(19) United States
(12) Patent Application Publication
(10) Pub. No.: US 2025/0389626 A1
(43) Pub. Date: Dec. 25, 2025

(54) MEMBRANE FOR SELECTIVE SEPARATION OF LUNG CANCER EXHALED BREATH BIOMARKER AND PREPARATION METHOD THEREOF

(71) Applicants: Tiangong University, Tianjin (CN); Institute of Biomedical Engineering, Chinese Academy of Medical Sciences, Tianjin (CN)

(72) Inventors: Weigui Fu, Tianjin (CN); Meixiu Sun, Tianjin (CN); Bojun Zhang, Tianjin (CN); Fengyun Su, Tianjin (CN); Yiping Zhao, Tianjin (CN); Li Chen, Tianjin (CN)

(73) Assignees: Tiangong University, Tianjin (CN); Institute of Biomedical Engineering, Chinese Academy of Medical Sciences, Tianjin (CN)

(21) Appl. No.: 18/946,995

(22) Filed: Nov. 14, 2024

(30) Foreign Application Priority Data
Jun. 20, 2024 (CN) 202410798625.0

(51) Int. Cl. G01N 1/34

(52) U.S. Cl. CPC G01N 1/34

(57) ABSTRACT

A composite membrane is provided/designed for separating isoprene, a biomarker for lung cancer in exhaled breath from acetone, along with a preparation method thereof. Glutaraldehyde and an amino compound containing a ketone group are used to modify aminofunctionalized metal-organic framework (UiO-66-NH₂). Glutaraldehyde contains two aldehyde (—CHO) groups, which bridges the amino (—NH₂) groups on the surface of UiO-66-NH₂ and the amino compound containing the ketone group respectively, through Schiff base reaction. This process allows for the grafting ketone group-containing molecules onto UiO-66-NH₂, resulting a novel composite adsorbent. Furthermore, the novel composite adsorbent is immobilized on the surface of a polymer-based flat sheet membrane using the vacuum filtration method, producing a modified composite membrane. The modified membrane demonstrates excellent separation performance of isoprene from acetone in human exhaled breath, which significantly reduces measurement errors caused by acetone in cavity ring-down spectroscopy (CRDS) tests.

### CROSS REFERENCE TO THE RELATED APPLICATIONS

This application is based upon and claims priority to Chinese Patent Application No. 202410798625.0, filed on Jun. 20, 2024, the entire contents of which are incorporated herein by reference.

### TECHNICAL FIELD

The present disclosure relates to a modification method for a polymer membrane material designed for the separation of organic gases (volatile organic compounds, VOCs) in human exhaled breath. Specifically, it focuses on a membrane material for separating isoprene, a biomarker for lung cancer found in exhaled breath, from acetone, along with a preparation method thereof.

### BACKGROUND

Lung cancer is one of the malignant tumors with the highest incidence and mortality worldwide. Early diagnosis and treatment are crucial for reducing the mortality of lung cancer. Therefore, developing effective screening methods for early diagnosis of lung cancer has become an urgent priority. Isoprene gas, found in human exhaled breath, is a potential biomarker of lung cancer, although its concentration is only at parts per billion by volume (ppbv) levels. Cavity ring-down spectroscopy (CRDS) technology enables non-invasive, real-time, accurate, and efficient measurement of lung cancer biomarkers in human exhaled breath, providing a foundation for early diagnosis and disease screening of lung cancer (CN201920790841.5). CRDS has detected strong absorption of isoprene gas at a wavelength of 226.56 nm; however, the absorption cross section is susceptible to interference from high concentrations of acetone (parts per million by volume, ppmv), which can compromise the accurate measurement of isoprene. Therefore, it is critical to develop a highly selective ultra-trace (ppbv level) isoprene/acetone gas separation membrane to minimize the interference of non-target component acetone on isoprene during spectral detection.

Metal-organic frameworks (MOFs) are a class of porous materials formed by interconnecting metal ions or metal clusters with organic ligands. This unique structural design imparts MOFs with extremely high specific surface area and adjustable pore sizes. Based on these properties, MOF materials exhibit excellent gas permeability and are particularly suitable for gas separation applications where high selectivity and permeability are required. Chinese invention patent (CN202210328309.8) discloses a UiO-66-NH₂ hollow fiber mixed matrix membrane prepared by steps of preparing filler by solvothermal method, ultrasonic dispersion of spinning solution, preparing membrane by dry-wet spinning method, etc. The membrane prepared by the method has a high gas permeation flux and is suitable for the selective separation of CO₂/N₂, CO₂/CH₄, O₂/N₂, and other gases, but there are still challenges in the interface compatibility between nanoscale filler and polymer matrix. As a functional MOF material, the amino (—NH₂) functional group in the molecular structure of UiO-66-NH₂ forms hydrogen bonds with [symbol] C═O [symbol] in carbonyl, aldehyde, carboxyl, and ester groups, so UiO-66-NH₂ can be used to adsorb polar gases such as CO₂ and acetone. However, in the process of isoprene/acetone gas separation, the number of active sites of —NH₂ functional groups on the surface of UiO-66-NH₂ is small, and the separation efficiency needs to be improved.

In the invention patent (CN202211161192.5) previously applied by the inventor, a polyvinylidene fluoride (PVDF)/polydimethylsiloxane (PDMS) hollow fiber membrane was used to separate isoprene and acetone from simulated human exhaled breath. The optimized modified membrane showed excellent selective separation performance under the transmembrane pressure of 0.2 MPa. However, because the base membrane was too dense and the gas penetration resistance was high, necessitating the use of an external gas cylinder for pressurization in gas transmission, which limits its direct application for filtering human exhaled breath samples. Therefore, the present disclosure intends to use glutaraldehyde and an amino compound containing a ketone group to modify UiO-66-NH₂, where the glutaraldehyde contains two-CHO groups, which can bridge the —NH₂ groups on the surface of UiO-66-NH₂ and the amino compound containing ketone group, respectively, by Schiff base reaction, to achieve the purpose of grafting of ketone group-containing molecules onto UiO-66-NH₂ and to obtain a novel composite adsorbent. Furthermore, the novel composite adsorbent is immobilized on the surface of commercial or homemade microporous base membranes using the vacuum filtration method to create a modified composite membrane. The modified membrane has excellent separation performance for isoprene and acetone in human exhaled breath, significantly reducing the measurement error caused by acetone in CRDS tests and providing better distinction and diagnostic capability between lung cancer patients and healthy individuals. The present disclosure has the advantages of simple operation, fast gas penetration, high selectivity, and fast, accurate, and efficient gas concentration detection both before and after passing through the membrane. This presents a new solution for the separation of isoprene and acetone gases in human exhaled breath.

### SUMMARY

Because the traditional UiO-66-NH₂ material has relatively few active sites of —NH₂ functional groups on its surface, its effect in the field of isoprene/acetone gas separation is not particularly ideal. The purpose of the present disclosure is to provide a composite membrane based on the UiO-66-NH₂ modified adsorbent for separating isoprene and acetone in human exhaled breath. The present disclosure uses glutaraldehyde and the amino compound containing ketone group, such as methyl 5-aminolevulinate hydrochloride or 2-amino-1-morpholinone, to modify UiO-66-NH₂, where the glutaraldehyde contains two-CHO groups, which can bridge the —NH₂ groups on the surface of UiO-66-NH₂ and the amino compound containing ketone group, respectively, by Schiff base reaction, to obtain a novel composite adsorbent, and then it is immobilized on the surface of a flat sheet ultrafiltration membrane by the vacuum filtration method to obtain the modified composite membrane. The modified membrane shows excellent separation performance of isoprene/acetone in human exhaled breath, which can significantly reduce the measurement error caused by spectral interference in CRDS tests and has a better distinction and diagnostic effect on lung cancer patients and healthy people. The preparation of the gas separation composite membrane mainly includes the following steps:
(1) ketonization modification of UiO-66-NH₂: adding 20-100 ml of N,N-dimethylformamide (DMF), 0.1-0.5 g of UiO-66-NH₂, and 2-10 mL of glutaraldehyde in a three-necked flask successively, mechanically stirring at 40-70° C. to react for 1-6 h; washing the reaction product with DMF to remove the unreacted monomers and obtain glutaraldehyde-modified UiO-66-NH₂, named UiO-66-GA; adding an amino compound containing ketone group in DMF containing UiO-66-GA, continuing to mechanically stir at 40-70° C. to react for 1-6 h; obtaining the orange-yellow powder by centrifugation, then washing alternately with DMF and anhydrous ethanol to remove the unreacted solvent; drying the sample overnight in a vacuum environment at a constant temperature of 60-100° C. to obtain ketonization-modified UiO-66-NH₂;
(2) preparation of modification solution: weighing a certain amount of polyvinyl alcohol (PVA) and deionized water in a three-necked flask and completely dissolving at 95-100° C. after full mechanical stirring to prepare a 0.5-5 wt % PVA solution, pouring it into a beaker for use; adding the ketonization-modified UiO-66-NH₂ in a prepared PVA solution, performing ultrasonic dispersion for 20-60 min, so that the modified UiO-66-NH₂ was fully dispersed and configured into a uniform mixed solution; and
(3) preparation of modified composite membrane: using homemade organic membrane or commercial organic flat sheet membrane as the base membrane, alternately cleaning with ethanol and distilled water; taking 1-10 mL of the above mixed solution and pouring into a vacuum filtration device for immobilizing it on the base membrane, taking out the membrane and putting into a vacuum oven to dry at 30-60° C. for 10-30 min to obtain the modified composite membrane.

The amino compound containing ketone group in step (1) may be one of methyl 5-aminolevulinate hydrochloride or 2-amino-1-morpholinone; the mass ratio of UiO-66-GA to the amino compound containing ketone group is 1:(0.1-10); further preferred is 1:(0.1-4);
the concentration of the ketonization-modified UiO-66-NH₂ solution in step (2) was 0.01-1 wt %;
the homemade membrane or commercial membrane in step (3) can be PVDF, polyvinyl chloride (PVC), polyether sulfone (PES), etc., where PVDF, PES, and other flat sheet membranes are preferred, with an average pore size of 0.1-0.45 μm, belonging to the ultrafiltration level.

The invention has the following beneficial technical effects: simple operation, excellent separation performance of the modified membrane on isoprene/acetone in human exhaled breath, significant reduction on the measurement error caused by spectral interference in CRDS tests, and better distinction and diagnostic effect on lung cancer patients and healthy people.

### BRIEF DESCRIPTION OF THE DRAWINGS

FIG. 1 shows scanning electron microscope (SEM) images of the PVDF/M5AH@UIO modified composite membrane prepared in Example 1, and the PVDF base membrane.

FIG. 2 illustrates a concentration comparison diagram between the PES/M5AH@UIO modified composite membrane prepared in Example 2 and the PVDF base membrane for isoprene/acetone gas separation.

FIG. 3 is a comparison diagram showing the isoprene concentration in exhaled breath between lung cancer patients and healthy subjects, using the PVDF/M5AH@UIO modified composite membrane prepared in Example 3.

PTR-TOF-MS Measurement: The PTR-TOF 1000 (proton transfer reaction time-of-flight mass spectrometry, PTR-TOF-MS) produced by Ionicon Analytik GmbH in Austria was used as a gold standard instrument for the quantitative detection of trace isoprene and acetone. In the experimental setup, a mixture of 500 ppbv isoprene/1000 ppbv acetone was used as a simulated human exhaled breath. Samples of exhaled breath from 76 lung cancer patients and 92 healthy volunteers were collected. PTR-TOF-MS was combined with a separation membrane to measure the concentration of the simulated human exhaled breath after it passed through the membrane, as well as the concentrations of actual human exhaled breath before and after passing through the membrane. Each gas sample was tested three times, with an intake volume of approximately 300 mL per test and a duration of 30 s for each test.

CRDS measurement: The main structure of the CRDS isoprene analysis system includes a vacuum ring-down cavity, a laser light source, a photoelectric detection module, and a data acquisition module. The off-line sampling method was selected for the accurate quantitative determination of isoprene concentration in human exhaled breath using CRDS technology. The human exhaled breath samples from 76 lung cancer patients and 92 healthy volunteers were measured. Each gas sample was tested three times, with an intake volume of about 500 mL for each test and each test lasting 60 s.

### DETAILED DESCRIPTION OF THE EMBODIMENTS

### Example 1

(1) Ketonization modification of UiO-66-NH₂: Firstly, 50 mL of DMF, 0.3 g of UiO-66-NH₂, and 5 mL of glutaraldehyde were weighed and added to a three-necked flask successively, heated to 60° C., and continued to react for 2 h; then, the reaction products were washed with DMF to remove the unreacted monomers, and glutaraldehyde-modified UiO-66-NH₂ (UiO-66-GA) was obtained. Next, 0.3 g of methyl 5-aminolevulinate hydrochloride (M5AH) was added to 50 mL of DMF containing 0.3 g of UiO-66-GA and continued to mechanically stir at 60° C. for 3 h. After that, the orange-yellow powder was obtained by centrifugation and washed alternately with DMF and anhydrous ethanol to remove the unreacted solvent. Finally, the sample was dried in a vacuum environment at a constant temperature of 80° C. overnight to obtain M5AH@UIO-66-NH₂.
(2) Preparation of modification solution: A certain amount of PVA and deionized water were weighed in a three-necked flask, and after full mechanical stirring, completely dissolved at 97° C., a 1 wt % PVA solution was prepared and poured into a beaker for use. The prepared PVA solution was added with 0.05 wt % M5AH@UIO-66-NH₂ and dispersed ultrasonic for 30 min, so that the modified UiO-66-NH₂ was fully dispersed and configured into a uniform mixed solution.
(3) Preparation of modified composite membrane: Commercial PVDF flat sheet membrane with an average pore size of 0.22 μm was used as the base membrane, which was cleaned alternately with ethanol and distilled water. 5 mL of the above mixed solution was taken and poured into the vacuum filtration device for immobilizing on the base membrane. The membrane was taken out and put into a vacuum oven to dry at 45° C. for 10 min. The obtained membrane was named PVDF/M5AH@UiO.

### Example 2

(1) Ketonization modification of UiO-66-NH₂: Firstly, 45 mL of DMF, 0.25 g of UiO-66-NH₂, and 5 mL of glutaraldehyde were weighed and added to a three-necked flask successively, heated to 50° C., and continued to react for 3 h; then, the reaction products were washed with DMF to remove the unreacted monomers, and glutaraldehyde-modified UiO-66-NH₂ (UiO-66-GA) was obtained. Next, 0.25 g of methyl 5-aminolevulinate hydrochloride (M5AH) was added to 50 mL of DMF containing 0.25 g of UiO-66-GA and continued to mechanically stir at 60° C. for 4 h. After that, the orange-yellow powder was obtained by centrifugation and washed alternately with DMF and anhydrous ethanol to remove the unreacted solvent. Finally, the sample was dried in a vacuum environment at a constant temperature of 80° C. overnight to obtain M5AH@UIO-66-NH₂.
(2) Preparation of modification solution: A certain amount of PVA and deionized water were weighed in a three-necked flask, and after full mechanical stirring, completely dissolved at 97° C., a 0.5 wt % PVA solution was prepared and poured into a beaker for use. The prepared PVA solution was added with 0.075 wt % M5AH@UIO-66-NH₂ and dispersed ultrasonic for 50 min, so that the modified UiO-66-NH₂ was fully dispersed and configured into a uniform mixed solution.
(3) Preparation of modified composite membrane: Commercial PES flat sheet membrane with an average pore size of 0.15 μm was used as the base membrane, which was cleaned alternately with ethanol and distilled water. 10 mL of the above mixed solution was taken and poured into the vacuum filtration device for immobilizing on the base membrane. The membrane was taken out and put into a vacuum oven to dry at 45° C. for 10 min. The obtained membrane was named PES/M5AH@UIO.

### Example 3

(1) Ketonization modification of UiO-66-NH₂: Firstly, 45 mL of DMF, 0.25 g of UiO-66-NH₂, and 5 mL of glutaraldehyde were weighed and added to a three-necked flask successively, heated to 70° C., and continued to react for 1 h; then, the reaction products were washed with DMF to remove the unreacted monomers, and glutaraldehyde-modified UiO-66-NH₂ (UiO-66-GA) was obtained. Next, 0.25 g of methyl 5-aminolevulinate hydrochloride (M5AH) was added to 50 mL of DMF containing 0.25 g of UiO-66-GA and continued to mechanically stir at 60° C. for 4 h. After that, the orange-yellow powder was obtained by centrifugation and washed alternately with DMF and anhydrous ethanol to remove the unreacted solvent. Finally, the sample was dried in a vacuum environment at a constant temperature of 80° C. overnight to obtain M5AH@UIO-66-NH₂.
(2) Preparation of modification solution: A certain amount of PVA and deionized water were weighed in a three-necked flask, and after full mechanical stirring, completely dissolved at 97° C., a 1 wt % PVA solution was prepared and poured into a beaker for use. The prepared PVA solution was added with 0.1 wt % M5AH@UIO-66-NH₂ and dispersed ultrasonic for 50 min, so that the modified UiO-66-NH₂ was fully dispersed and configured into a uniform mixed solution.
(3) Preparation of modified composite membrane: Commercial PVDF flat sheet membrane with an average pore size of 0.45 μm was used as the base membrane, which was cleaned alternately with ethanol and distilled water. 10 mL of the above mixed solution was taken and poured into the vacuum filtration device for immobilizing on the base membrane. The membrane was taken out and put into a vacuum oven to dry at 45° C. for 30 min. The obtained membrane was named PVDF2/M5AH@UiO.

### Experimental Comparison Example

The commercial PVDF flat sheet membrane with an average pore size of 0.22 μm was washed with an ethanol solution and then dried under vacuum to obtain the PVDF base membrane required for this experiment.

### Experiment Effect

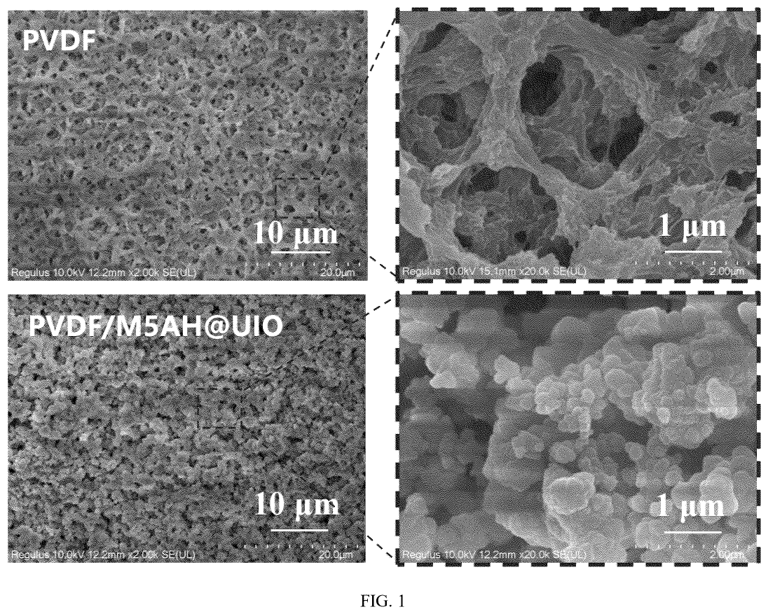

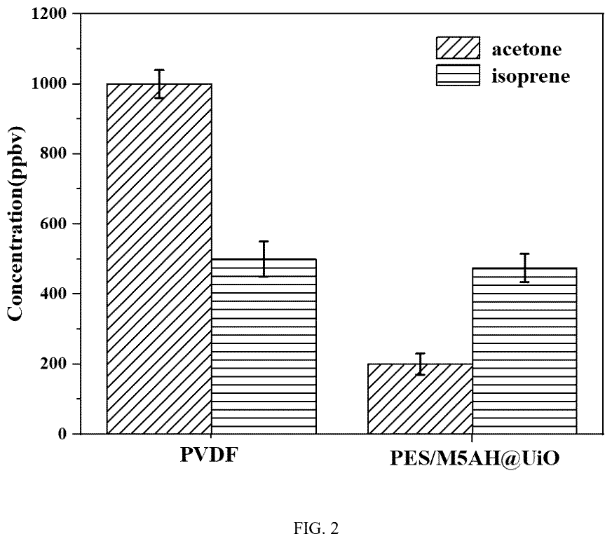

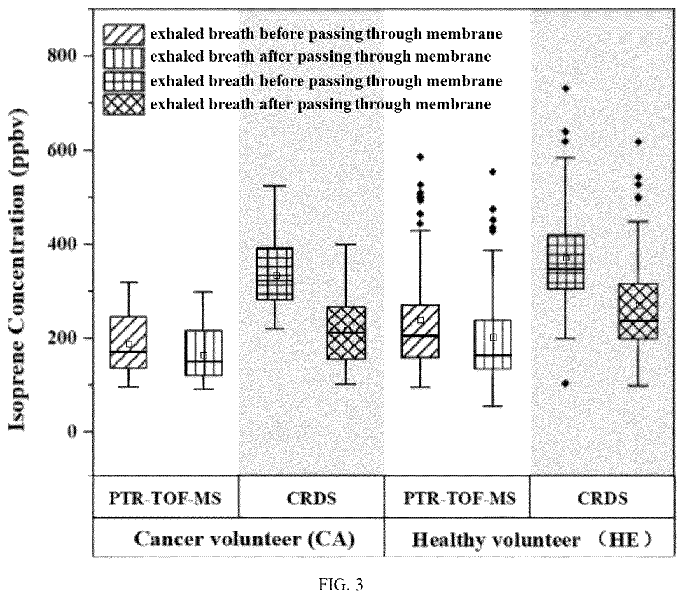

The present disclosure designs and prepares a membrane material for isoprene/acetone gas separation in human exhaled breath, and the composite membrane exhibits excellent separation effect in human exhaled breath separation tests. The results were obtained by a comparison test between the commercial PVDF base membrane in the Experimental comparison example and the modified membranes prepared in Examples 1, 2, and 3:
(1) FIG. 1 of the specification shows SEM images of the PVDF base membrane in the comparison example and the PVDF/M5AH@UIO modified composite membrane in Example 1. The PVDF base membrane showed a loose porous structure, while the surface of the PVDF/M5AH@UIO composite membrane has a uniform distribution of UiO-66-NH₂, and the basic morphology of membrane pores can be maintained. Due to the small amount of PVA coating, the surface of nanoparticles presents smoother characteristics.
(2) As shown in FIG. 2 of the specification, the separation concentration of the 500 ppbv isoprene/1000 ppbv acetone mixture in PVDF base membrane and PES/M5AH@UIO modified composite membrane in Example 2 was measured by the PTR-TOF-MS 1000 system. When simulated human exhaled breath was separated by the PES/M5AH@UIO membrane, the concentration of acetone decreased by 89.21% from 1000 ppbv to 106.88 ppbv and the concentration of isoprene decreased slightly from 500 ppbv to 455 ppbv by 8.85%. The result indicated that PES/M5AH@UIO modified membrane exhibited excellent performance in the selective separation of isoprene and acetone.
(3) FIG. 3 of the specification shows the comparison of isoprene concentration in exhaled breath of lung cancer patients and healthy subjects before and after the separation with PVDF2/M5AH@UIO modified composite membrane in Example 3. PTR-TOF-MS 1000 and CRDS isoprene system were used to detect gas concentration, respectively. The results of PTR-TOF-MS showed that the concentration of isoprene in the exhaled breath of healthy people (238.67+106.24 ppbv) was significantly higher than that of lung cancer patients (169.03+52.59 ppbv). The results of CRDS showed that after passing through the modified membrane, the detection concentration of isoprene in lung cancer patients decreased from 294.79+65.42 ppbv to 191.05+56.01 ppbv, which effectively reduced the error caused by spectral interference in the CRDS test and improved the detection accuracy of isoprene. In healthy volunteers, both PTR-TOF-MS and CRDS measurements showed a similar trend in isoprene concentration in exhaled breath before and after membrane treatment as in lung cancer patients. This result highlights the importance of membrane separation technology in the processing of human exhaled breath samples, especially for the accurate measurement of isoprene concentration in exhaled breath using CRDS technology.

What is claimed is:

1. A membrane for a selective separation of a lung cancer exhaled breath biomarker, wherein glutaraldehyde and an amino compound containing a ketone group are used to modify UiO-66-NH₂, wherein the glutaraldehyde contains an aldehyde group at each of a first end and a second end, and a composite adsorbent is obtained by bridging an amino group on a surface of the UiO-66-NH₂ at the first end and the amino compound containing the ketone group at the second end through a Schiff base reaction, and then the composite adsorbent is immobilized on a surface of a polymer-based flat sheet ultrafiltration membrane by a vacuum filtration method to obtain a modified composite membrane; the modified composite membrane shows an excellent separation performance of isoprene/acetone in human exhaled breath, significantly reduces a measurement error caused by acetone in a cavity ring-down spectroscopy (CRDS) test, and has a better distinction and diagnostic effect on lung cancer patients and healthy people; wherein a preparation method of the modified composite membrane comprises the following steps:
(1) a ketonization modification of the UiO-66-NH₂: adding 20-100 mL of N,N-dimethylformamide (DMF), 0.1-0.5 g of the UiO-66-NH₂, and 2-10 mL of the glutaraldehyde in a first three-necked flask successively, mechanically stirring at 40-70° C. to react for 1-6 h; washing a reaction product with the DMF to remove unreacted monomers and obtain glutaraldehyde-modified UiO-66-NH₂, named UiO-66-GA; adding the amino compound containing the ketone group in DMF containing the UiO-66-GA, continuing to mechanically stir at 40-70° C. to react for 1-6 h; obtaining an orange-yellow powder by a centrifugation, then washing alternately with the DMF and anhydrous ethanol to remove an unreacted solvent and obtain a sample; drying the sample overnight in a vacuum environment at a constant temperature of 60-100° C. to obtain ketonization-modified UiO-66-NH₂;
(2) a preparation of a modification solution: weighing a predetermined amount of polyvinyl alcohol (PVA) and deionized water in a second three-necked flask, and completely dissolving at 95-100° C. after a full mechanical stirring to prepare a 0.5-5 wt % PVA solution, pouring the 0.5-5 wt % PVA solution into a beaker for use; adding the ketonization-modified UiO-66-NH₂ in the 0.5-5 wt % PVA solution, performing an ultrasonic dispersion for 20-60 min, so that the ketonization-modified UiO-66-NH₂ is fully dispersed to form a mixed system; and
(3) a preparation of the modified composite membrane: using a homemade organic membrane or a commercial organic flat sheet membrane as a base membrane, alternately cleaning with ethanol and distilled water; taking 1-10 mL of the modification solution and pouring into a vacuum filtration device for immobilizing the modification solution on the base membrane, taking out a treated membrane from the vacuum filtration device and putting into a vacuum oven to dry at 30-60° C. for 10-30 min to obtain the modified composite membrane.

2. The membrane for the selective separation of the lung cancer exhaled breath biomarker according to claim 1, wherein the base membrane is selected from one of a commercial membrane or a homemade membrane, and has a morphology selected from a flat sheet membrane and a material selected from one of polyvinylidene fluoride (PVDF), polyvinyl chloride (PVC), or polyether sulfone (PES).

3. The membrane for the selective separation of the lung cancer exhaled breath biomarker according to claim 1, wherein the amino compound containing the ketone group is selected from one of methyl 5-aminolevulinate hydrochloride or 2-amino-1-morpholinone.

4. The membrane for the selective separation of the lung cancer exhaled breath biomarker according to claim 1, wherein a mass ratio of the UiO-66-GA to the amino compound containing the ketone group in the step (1) is 1:(0.1-10).

5. The membrane for the selective separation of the lung cancer exhaled breath biomarker according to claim 1, wherein a concentration of a ketonization-modified UiO-66-NH₂ solution in the step (2) is 0.01-1 wt %.
